(19) United States
(12) Patent Application Publication
(10) Pub. No.: US 2023/0076370 A1
(43) Pub. Date: Mar. 9, 2023

(54) Foldable Cat Scratching Board

(71) Applicant: Juncheng Li, Shenzhen (CN)

(72) Inventor: Juncheng Li, Shenzhen (CN)

(21) Appl. No.: 17/942,194

(22) Filed: Sep. 12, 2022

(51) Int. Cl. A01K 15/02; F16M 11/38

(52) U.S. Cl. CPC A01K 15/024; F16M 11/38

(57) ABSTRACT

The present invention provides a foldable cat scratching board, which comprises a base assembly, a first inclined plate assembly installed on the base assembly, and a second inclined plate assembly installed on the first inclined plate assembly; wherein a locking assembly is arranged between the first inclined plate assembly and the second inclined plate assembly, the first inclined plate assembly and the second inclined plate assembly are pivotally hinged by the locking assembly; the first inclined plate assembly is detachably connected with the base assembly. The present invention has the advantages that by adopting the described solution, only the base of the assembled cat scratching board contacts the ground, so that the occupied area is small; moreover, the vertical space can be well utilized, which can satisfy the cats' habit of climbing.

### TECHNICAL FIELD

The present invention belongs to the field of cat scratching boards, in particular to a foldable cat scratching board.

### BACKGROUND

The cat scratching board is designed according to the cat's habit of grinding claws. Because the cat's nails are sharp, it is necessary to peel off the aged cutin on the claws by grinding the claws. Therefore, the cat will take the furniture or clothes in the home as the object of grinding claws, which will cause the furniture and clothes to be damaged. Therefore, in order to protect the furniture and personal clothes at home from pet damage, cat owners usually use a cat scratching board to provide a comfortable and safe environment for grinding claws.

However, the existing cat scratching boards are mostly fixed structures, such as the common straight board or inclined board structures. The straight board structure has a relatively large structure and occupies a large area. The inclined board structure can make good use of the vertical space, and it is more beneficial for cats to grind their paws while satisfying their climbing habits. However, the inclined board structure occupies a large space, which is inconvenient for daily transportation and is not conducive to the promotion of the cat scratching board.

### SUMMARY

The main object of the present invention is to provide a foldable cat scratching board. A base assembly is detachably connected with a first inclined plate assembly, and a second inclined plate assembly is pivotally hinged with the first inclined plate assembly by a locking assembly, so that only the base of the assembled cat scratching board is in contact with the ground, the occupied area is small, the vertical space can be well utilized, and the cat's habit of climbing can be met. In the transportation process, the second inclined plate assembly and the first inclined plate assembly can be folded, and the base assembly and the first inclined plate assembly can be disassembled, so that the problem of large space occupation in the transportation process is overcome, daily transportation is facilitated, and the popularization of cat scratching boards is facilitated.

To solve the above technical problems, the present invention provides the following technical solution.

A foldable cat scratching board, including a base assembly, a first inclined board assembly mounted on the base assembly, and a second inclined board assembly mounted on the first inclined board assembly; wherein a locking assembly is arranged between the first inclined plate assembly and the second inclined plate assembly, the first inclined plate assembly and the second inclined plate assembly are pivotally hinged by the locking assembly, and the first inclined plate assembly is detachably connected with the base assembly.

As a preferred solution of the foldable cat scratching board, the first inclined board assembly includes a first mounting bracket, and the second inclined board assembly includes a second mounting bracket; the locking assembly includes a hinge shaft and a locking button sleeved on the hinge shaft, wherein the first mounting bracket is pivotally hinged with the second mounting bracket by the hinge shaft; the locking button is provided with a first locking projection and a second locking projection, the first mounting bracket is provided with a first locking groove, and the second mounting bracket is provided with a second locking groove; the locking button is sleeved behind the hinge shaft, the first locking projection is clamped with the first locking groove, and the second locking projection is clamped with the second locking groove, so that the first inclined plate assembly is locked with respect to the second inclined plate assembly; after the locking button is pulled to the outside of the locking button, the first locking protrusion comes out of the first locking groove, and the second locking protrusion comes out of the second locking groove, so that the first inclined plate assembly is unlocked relative to the second inclined plate assembly.

As a preferred solution of the foldable cat scratching board, the locking assembly is further provided with a reset spring which is sleeved on the hinge shaft; one end of the reset spring abuts against the hinge shaft, and the other end of the reset spring abuts against the outside of the locking button; and the reset spring is used for resetting the locking button.

As a preferred solution of the foldable cat scratching board, the base assembly includes a base lower cover and a base upper cover detachably mounted on the base lower cover; wherein two sides of the base upper cover extend toward the first mounting bracket to form a clamping hook, the first mounting bracket is provided with a clamping groove, and the clamping hook is clamped with the clamping groove.

As a preferred solution of the foldable cat scratching board, the first inclined board assembly further includes a first inclined board, wherein the first mounting bracket is provided with a first mounting groove, and the first inclined board is detachably mounted in the first mounting groove by screws; the second inclined plate assembly further includes a second inclined plate, wherein the second mounting bracket is provided with a second mounting groove, and the second inclined plate is detachably mounted in the second mounting groove by screws.

As a preferred solution of the foldable cat scratching board, the first mounting bracket is provided with a first hemispherical groove, and the base assembly is provided with a second hemispherical groove; wherein after the base assembly is clamped with the first mounting bracket, the first hemispherical groove and the second hemispherical groove are spliced into a spherical groove, and a cat scratching ball is arranged in the spherical groove.

As a preferred solution of the foldable cat scratching board, the inner and outer groove walls of the spherical groove extend inward to form an abutting projection, so that a diameter of an opening of the spherical groove is smaller than a diameter of the cat scratching ball.

As a preferred solution of the foldable cat scratching board, a hook is arranged on a bottom surface of the second mounting bracket, and the hook is used for hanging cat teasing devices.

As a preferred solution of the foldable cat scratching board, an anti-slip pad is arranged at a bottom of the base assembly.

As a preferred solution of the foldable cat scratching board, both the first inclined board assembly and the second inclined board assembly are arc-shaped.

The present invention has the following advantages.

According to the present invention, the foldable cat scratching board, which includes a base assembly, a first inclined plate assembly installed on the base assembly, and a second inclined plate assembly installed on the first inclined plate assembly; wherein a locking assembly is arranged between the first inclined plate assembly and the second inclined plate assembly, the first inclined plate assembly and the second inclined plate assembly are pivotally hinged by the locking assembly; the first inclined plate assembly is detachably connected with the base assembly. By adopting the described solution, only the base of the assembled cat scratching board contacts the ground, so that the occupied area is small; moreover, the vertical space can be well utilized, which can satisfy the cats' habit of climbing. In the transportation process, the second inclined plate assembly and the first inclined plate assembly can be folded, and the base assembly and the first inclined plate assembly can be detached, so that the problem of large space occupation in the transportation process is overcome, daily transportation is facilitated, and the popularization of cat scratching boards is facilitated.

### BRIEF DESCRIPTION OF DRAWINGS

In order to explain the technical solution in the embodiments of the present invention more clearly, the drawings needed in the description of the embodiments will be briefly explained below. Obviously, the drawings in the following description are only some embodiments of the present invention. For those of ordinary skill in the art, other drawings can be obtained according to these drawings without creative labor, all of which fall into the scope of protection of the present invention. In the drawings:

FIG. 1 is a structural schematic diagram of a foldable cat scratching board according to the present invention;

FIG. 2 is an explosion schematic diagram of the foldable cat scratching board shown in FIG. 1;

FIG. 3 is a partial explosion schematic diagram of the hinge of a first inclined plate assembly and a second inclined plate assembly of the foldable cat scratching board shown in FIG. 2;

FIG. 4 is a structural diagram of a locking button of the foldable cat scratching board shown in FIG. 3;

FIG. 5 is a structural diagram of the first inclined plate assembly of the foldable cat scratching board shown in FIG. 2;

FIG. 6 is an exploded schematic diagram of the first inclined plate assembly of the foldable cat scratching board shown in FIG. 5;

FIG. 7 is a structural schematic diagram of a first mounting bracket of the foldable cat scratching board shown in FIG. 6;

FIG. 8 is a structural diagram of the second inclined plate assembly of the foldable cat scratching board shown in FIG. 2;

FIG. 9 is an exploded schematic diagram of the second inclined plate assembly of the foldable cat scratching board shown in FIG. 8;

FIG. 10 is a structural schematic diagram of a second mounting bracket of the foldable cat scratching board shown in FIG. 9;

FIG. 11 is a structural schematic diagram of a base assembly of the foldable cat scratching board and the cat scratching ball shown in FIG. 2;

FIG. 12 is a cross-sectional view of the base assembly of the foldable cat scratching board and the cat scratching ball shown in FIG. 2.

### DESCRIPTION OF EMBODIMENTS

The technical solutions in the embodiments of the present invention will be clearly and completely described below. Obviously, the described embodiments are only part of the embodiments of the present invention, but not all of the embodiments. Based on the embodiment of the present invention, all other embodiments obtained by those skilled in the art without creative labor fall within the scope of protection of the present invention.

Therefore, the following detailed description of the embodiments of the present invention provided in the drawings is not intended to limit the scope of the claimed invention, but only to represent selected embodiments of the present invention. It should be noted that without conflict, various features in the embodiments of the present invention can be combined with each other, and the combined embodiments are still within the scope of protection of the present invention.

In the description of the present invention, it should also be noted that unless otherwise specified and limited, the terms “set”, “installed”, “connect” and “connected” should be understood in a broad sense, for example, they can be fixedly connected, detachably connected or integrally connected; the connection can be mechanical connection or electrical connection; it can be direct connection or indirect connection by an intermediate medium, or it can be the internal communication of two elements. For those of ordinary skill in the art, the specific meanings of the above terms in the present invention can be understood in specific situations.

The cat scratching board is designed according to the cat's habit of grinding claws. Because the cat's nails are sharp, it is necessary to peel off the aged cutin on the claws by grinding the claws. Therefore, the cat will take the furniture or clothes in the home as the object of grinding claws, which will cause the furniture and clothes to be damaged. Therefore, in order to protect the furniture and personal clothes at home from pet damage, cat owners usually use the cat scratching board to provide a comfortable and safe environment for grinding claws.

However, the existing cat scratching boards are mostly fixed structures, such as the common straight board or inclined board structures. The straight board structure has a relatively large structure and occupies a large area. The inclined board structure can make good use of vertical space, and it is more beneficial for cats to grind their paws while satisfying their climbing habits. However, the inclined board structure occupies a large space, which is inconvenient for daily transportation and is not conducive to the promotion of cat scratching board.

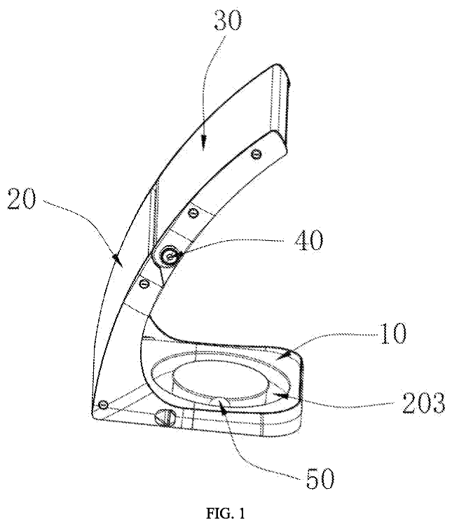

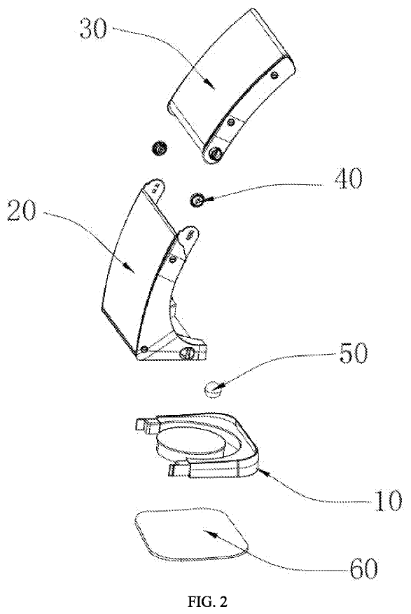

As shown in FIGS. 1 and 2, an embodiment of the present invention provides a foldable cat scratching board, which includes a base assembly 10, a first inclined board assembly 20 installed on the base assembly 10, and a second inclined board assembly 30 installed on the first inclined board assembly 20.

A locking assembly 40 is arranged between the first inclined plate assembly 20 and the second inclined plate assembly 30, the first inclined plate assembly 20 and the second inclined plate assembly 30 are pivotally hinged by the locking assembly 40, and the first inclined plate assembly 20 is detachably connected with the base assembly 10.

In the present invention, by adopting the above solution, the base assembly 10 is detachably connected with the first inclined plate assembly 20; the bottom surface of the base assembly 10 is attached to the ground, and the second inclined plate assembly 30 and the first inclined plate assembly 20 are pivotally hinged with each other through the locking assembly 40, so that only the base assembly 10 is in contact with the ground in the assembled cat scratching board, which occupies a small area and can make good use of the vertical space and satisfy the cat's habit of climbing. In the transportation process, the second inclined plate assembly 30 and the first inclined plate assembly 20 can be folded, and the base assembly 10 and the first inclined plate assembly 20 can be detached, so that the problem of large space occupation in the transportation process is overcome, daily transportation is facilitated, and the popularization of cat scratching board is facilitated.

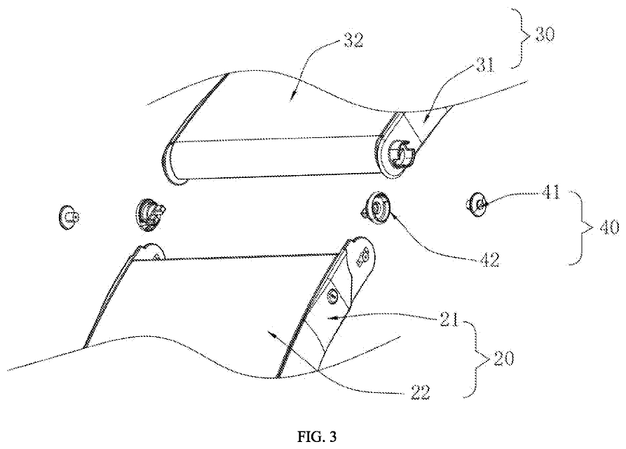

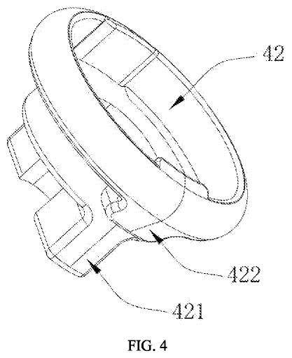

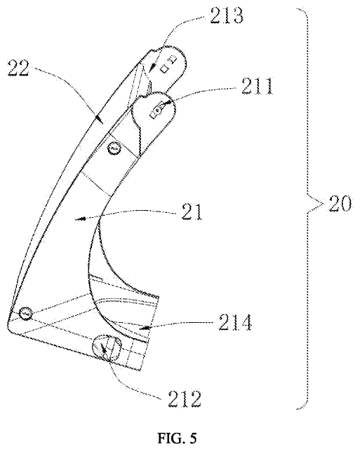

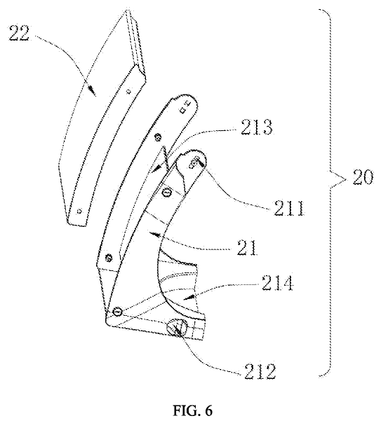

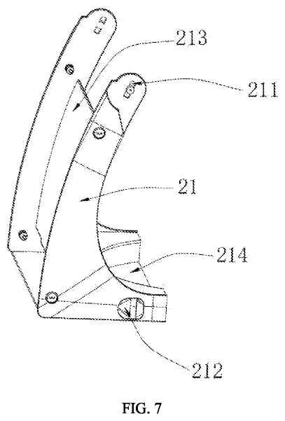

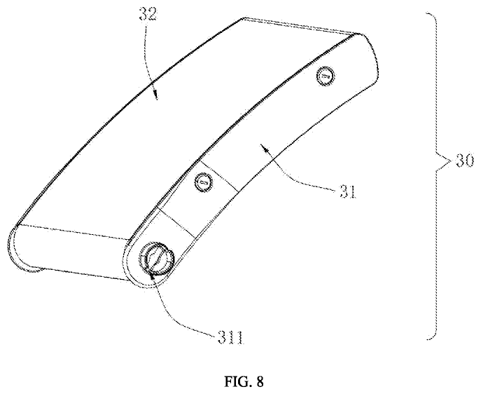

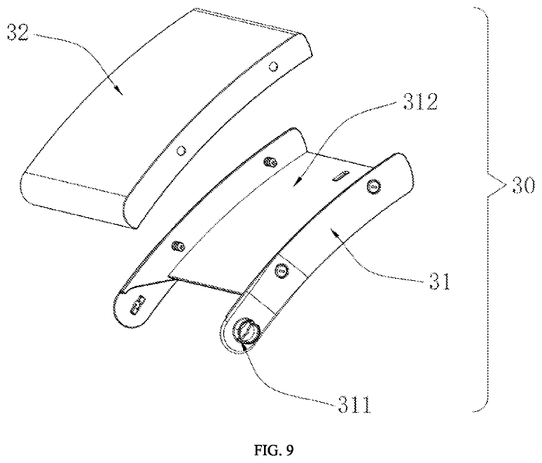

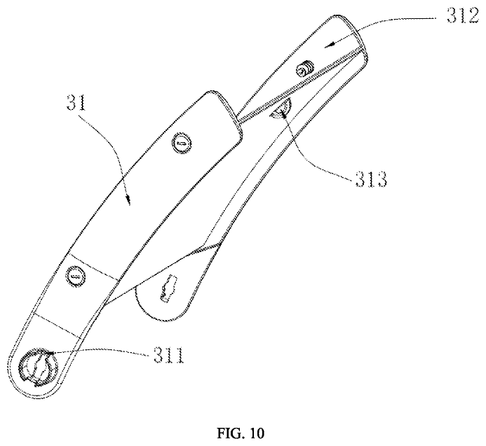

As shown in FIG. 3, FIG. 4, FIG. 5, FIG. 6, FIG. 7, FIG. 8, FIG. 9 and FIG. 10, in order to make the first inclined plate assembly 20 and the second inclined plate assembly 30 foldable, the first inclined plate assembly 20 includes a first mounting bracket 21, the second inclined plate assembly 30 includes a second mounting bracket 31; the locking assembly 40 includes a hinge shaft 41 and a locking button 42 sleeved on the hinge shaft 41, and the first mounting bracket 21 is pivotally hinged with the second mounting bracket 31 by the hinge shaft 41.

The locking button 42 is provided with a first locking protrusion 421 and a second locking protrusion 422; the first mounting bracket 21 is provided with a first locking groove 211 at a position corresponding to the first locking protrusion 421, and the second mounting bracket 31 is provided with a second locking groove 311 at a position corresponding to the second locking protrusion 422; the first locking protrusion 421 can be clamped with and disengaged from the first locking groove 211, and the second locking protrusion 422 can be clamped with and disengaged from the second locking groove 311, so that the second inclined plate assembly 30 can be locked and unlocked relative to the first inclined plate assembly 20.

Specifically, after the first mounting bracket 21 is pivotally hinged with the second mounting bracket 31, the locking button 42 is sleeved on the hinge shaft 41, the first locking protrusion 421 is clamped with the first locking groove 211, and the second locking protrusion 422 is clamped with the second locking groove 311, so that the first inclined plate assembly 20 is locked with respect to the second inclined plate assembly 30.

After the locking button 42 is pulled to the outside of the locking button 42, the first locking protrusion 421 comes out of the first locking groove 211, and the second locking protrusion 422 comes out of the second locking groove 311, so that the first writing board assembly is unlocked relative to the second inclined board assembly 30.

In order to enable the locking button 42 to be reset after being pulled outward, the locking assembly 40 is further provided with a reset spring 43 sleeved on the hinge shaft 41; one end of the reset spring 43 abuts against the hinge shaft 41, and the other end of the reset spring 43 abuts against the outer side of the locking button 42; the reset spring 43 is used for resetting the locking button 42.

When the locking button 42 is pulled to the outside of the locking button 42, the first locking protrusion 421 comes out of the first locking groove 211, the second locking protrusion 422 comes out of the second locking groove 311, and the reset spring 43 is compressed. When the locking button 42 is released, it rotates until the first locking protrusion 421 aligns with the first locking groove 211 and the second locking protrusion 422 aligns with the second locking groove 311, thereby the elastic force of the reset spring 43 is released, so that the first locking protrusion 421 is clamped with the first locking groove 211 and the second locking protrusion 422 is clamped with the second locking groove 311.

In order to detachably mount the base assembly 10 on the first inclined plate assembly 20, the base assembly 10 includes a base lower cover 11 and a base upper cover 12 detachably mounted on the base lower cover 11. The base upper cover 12 extends toward the first mounting bracket 21 to form a hook 121; the first mounting bracket 21 is provided with a clamping groove 212 at a position corresponding to the hook 121, and the hook 121 is clamped with the clamping groove 212, so that the base assembly 10 can be detachably mounted on the first inclined plate assembly 20 conveniently and quickly.

To assemble the first inclined plate assembly 20 and the second inclined plate assembly 30, the first inclined plate assembly 20 further includes a first inclined plate 22; the first mounting bracket 21 is provided with a first mounting groove 213 at a position corresponding to the first inclined plate 22, and the first inclined plate 22 is detachably mounted in the first mounting groove 213 by screws; the second inclined plate assembly 30 further includes a second inclined plate 32; the second mounting bracket 31 is provided with a second mounting groove 312 at a position corresponding to the second inclined plate 32; the second inclined plate 32 is detachably mounted in the second mounting groove 312 by screws; the first inclined plate 22 and the second inclined plate 32 are used for grinding cats' claws. In the present invention, the first inclined plate 22 and the second inclined plate 32 are preferably corrugated paper, but is not limited to this embodiment. No limitation is made in the present invention, as long as the first inclined plate 22 and the second inclined plate 32 can be used for cat claws grinding.

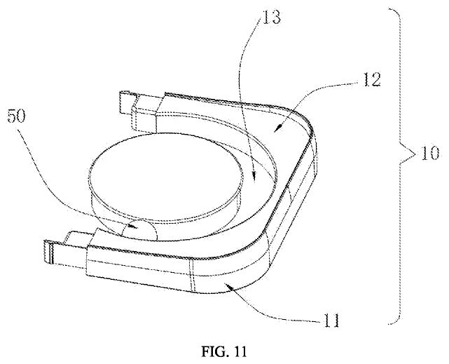

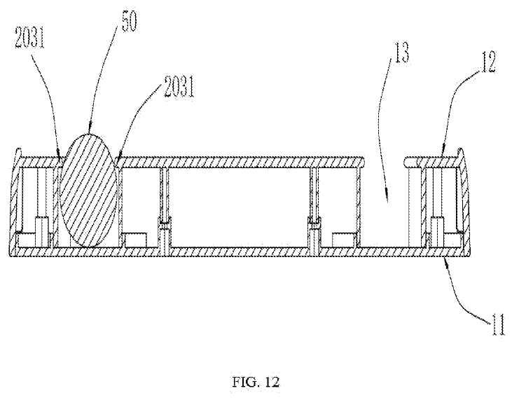

As shown in FIGS. 11 and 12, in order to increase the interestingness of the foldable cat scratching board, the first mounting bracket 21 is provided with a first hemispherical groove 214, and the base assembly 10 is provided with a second hemispherical groove 13 at a position corresponding to the first hemispherical groove 214. After the base assembly 10 is clamped with the first mounting bracket 21, the first hemispherical groove 214 and the second hemispherical groove 13 are combined into a spherical groove 203. A cat scratching ball 50 is arranged in the spherical groove 203, and the cat scratching ball 50 can provide entertainment for cats.

In order to prevent the cat scratching ball 50 from escaping from the spherical groove 203, the inner and outer groove walls of the spherical groove 203 protrude inward to form an abutting projection 2031, so that the diameter of the opening of the spherical groove 203 is smaller than that of the cat scratching ball 50, and the cat scratching ball 50 is prevented from being lost after escaping from the spherical groove 203.

In order to further increase the interestingness of the foldable cat scratching board, a hook 313 is arranged on the bottom surface of the second mounting bracket 31, and the hook 313 is used for hanging cat teasing devices, such as cat teasing ropes or cat teasing balls, which is not limited by the present invention.

In order to increase the stability of the foldable cat scratching board, an anti-slip pad 60 is provided at the bottom of the base assembly 10, and the anti-slip pad 60 is used for anti-slip of the foldable cat scratching board.

In order to increase the stability and appreciation of the foldable cat scratching board, both the first inclined board assembly 20 and the second inclined board assembly 30 are arc-shaped, so that the cat can keep stable when climbing on the foldable cat scratching board, and its appreciation is also improved to some extent.

The present invention has been explained in detail with reference to the above drawings, but the present invention is not limited to the described embodiments. For those skilled in the art, many changes, modifications, substitutions and variations can be made to these embodiments without departing from the principle and spirit of the present invention, which still fall within the scope of protection of the present invention.

What is claimed is:

1. A foldable cat scratching board, comprising a base assembly, a first inclined board assembly mounted on the base assembly, and a second inclined board assembly mounted on the first inclined board assembly;
wherein a locking assembly is arranged between the first inclined plate assembly and the second inclined plate assembly, the first inclined plate assembly and the second inclined plate assembly are pivotally hinged by the locking assembly, and the first inclined plate assembly is detachably connected with the base assembly.

2. The foldable cat scratching board according to claim 1, characterized in that the first inclined board assembly comprises a first mounting bracket, and the second inclined board assembly comprises a second mounting bracket;
wherein the locking assembly comprises a hinge shaft and a locking button sleeved on the hinge shaft, wherein the first mounting bracket is pivotally hinged with the second mounting bracket by the hinge shaft;
the locking button is provided with a first locking projection and a second locking projection, the first mounting bracket is provided with a first locking groove, and the second mounting bracket is provided with a second locking groove;
the locking button is sleeved behind the hinge shaft, the first locking projection is clamped with the first locking groove, and the second locking projection is clamped with the second locking groove, so that the first inclined plate assembly is locked with respect to the second inclined plate assembly;
after the locking button is pulled to the outside of the locking button, the first locking protrusion comes out of the first locking groove, and the second locking protrusion comes out of the second locking groove, so that the first inclined plate assembly is unlocked relative to the second inclined plate assembly.

3. The foldable cat scratching board according to claim 2, characterized in that the locking assembly is further provided with a reset spring which is sleeved on the hinge shaft; one end of the reset spring abuts against the hinge shaft, and the other end of the reset spring abuts against the outside of the locking button; and the reset spring is used for resetting the locking button.

4. The foldable cat scratching board according to claim 2, characterized in that the base assembly comprises a base lower cover and a base upper cover detachably mounted on the base lower cover;
wherein two sides of the base upper cover extend toward the first mounting bracket to form a clamping hook, the first mounting bracket is provided with a clamping groove, and the clamping hook is clamped with the clamping groove.

5. The foldable cat scratching board according to claim 4, characterized in that the first inclined board assembly further comprises a first inclined board, wherein the first mounting bracket is provided with a first mounting groove, and the first inclined board is detachably mounted in the first mounting groove by screws;
the second inclined plate assembly further comprises a second inclined plate, wherein the second mounting bracket is provided with a second mounting groove, and the second inclined plate is detachably mounted in the second mounting groove by screws.

6. The foldable cat scratching board according to claim 5, characterized in that the first mounting bracket is provided with a first hemispherical groove, and the base assembly is provided with a second hemispherical groove;
wherein after the base assembly is clamped with the first mounting bracket, the first hemispherical groove and the second hemispherical groove are spliced into a spherical groove, and a cat scratching ball is arranged in the spherical groove.

7. The foldable cat scratching board according to claim 6, characterized in that the inner and outer groove walls of the spherical groove extend inward to form an abutting projection, so that a diameter of an opening of the spherical groove is smaller than a diameter of the cat scratching ball.

8. The foldable cat scratching board according to claim 5, characterized in that a hook is arranged on a bottom surface of the second mounting bracket, and the hook is used for hanging cat teasing devices.

9. The foldable cat scratching board according to claim 1, characterized in that an anti-slip pad is arranged at a bottom of the base assembly.

10. The foldable cat scratching board according to claim 1, characterized in that both the first inclined board assembly and the second inclined board assembly are arc-shaped.
